(19) United States
(12) Patent Application Publication
(10) Pub. No.: US 2008/0305442 A1
(43) Pub. Date: Dec. 11, 2008

(54) Patterned material layer, method of forming the same, microdevice, and method of manufacturing the same

(75) Inventors: Kazuki Sato, Tokyo (JP); Akifumi Kamijima, Tokyo (JP); Takayasu Kanaya, Tokyo (JP); Kei Hirata, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/806,959

(22) Filed: Jun. 5, 2007

(51) Int. Cl. G03C 5/00

(52) U.S. Cl. 430/324

(57) ABSTRACT

A formation method for a patterned material layer comprising a step of exposing a composite layer to light in a predetermined pattern, the composite layer including a first photosensitive resin layer, a protective film, and an upper resin layer; a step of partly removing the exposed composite layer so as to form an opening exposing the substrate and form a groove along the main surface of the substrate on a side face of the opening by depressing the end portion of the upper resin layer on the substrate side, thereby forming a resist frame comprising the composite layer formed with the opening; a step of forming a vacuum coated layer having a material pattern part formed on the substrate in the opening and a part to lift off formed on the resist frame, by vacuum coating process; and a step of removing the part to lift off together with the resist frame, so as to yield a patterned material layer.

### BACKGROUND OF THE INVENTION

1. Field of the Invention

The present invention relates to a patterned material layer, a method of forming the same, a microdevice, and a method of manufacturing the same.

2. Related Background Art

Microdevices such as thin film magnetic heads, thin film inductors, semiconductor devices, thin film sensors and thin film actuators generally have a material layer with a prescribed pattern, which is formed from a material that is magnetic, conductive or the like. When manufacturing such microdevices, the patterned material layer is formed, for example, by removing, through milling, the unnecessary portion of a film formed by a vacuum coating such as a sputtering, or is formed by a so-called frame plating that uses a resist frame formed using a photosensitive resin (refer to, for example, Japanese Unexamined Patent Application Nos. H11-175915, 2001-23984, and 2002-197612).

### SUMMARY OF THE INVENTION

Methods forming a material layer by vacuum coating can easily turn various materials into thin films and can employ a wide range of materials. In the case of magnetic materials, for example, these methods are also advantageous in that they yield material layers with a saturated magnetic flux density higher than that in material layers formed by frame plating.

However, when the material layer is formed by a vacuum coating, a pattern is generally formed by removing the unnecessary portions by a method such as milling, thus there is a tendency for the precision (contrast and the like) of the pattern to be lower in comparison to a frame plating. When patterning a material layer by milling, gentle sloping of the side surfaces cannot be avoided, thus it is difficult for the side surfaces of the patterned material layer to form right angles with the substrate. In particular, in the case in which the material layer is formed from an inorganic material such as metal and the material layer has a certain degree of thickness, it has been extremely difficult to perform patterning that obtains side surfaces that are perpendicular to the substrate when using a vacuum coating. Therefore, it has conventionally been inevitable in practice to employ other methods such as frame plating when patterning a material layer having a certain extent of thickness.

In view of the foregoing circumstances, it is an object of the present invention to provide a method of forming a patterned material layer which can pattern a material layer formed on a substrate by vacuum coating with a sufficiently high accuracy and can easily form a right angle between a side face and the substrate.

The formation method for a patterned material layer according to the present invention comprises a step of forming a first photosensitive resin layer on the substrate; a step of forming a protective film covering the surface of the first photosensitive resin layer on the side opposite the substrate; a step of forming an upper resin layer on the protective film, the upper resin layer having a second photosensitive resin layer; a step of exposing a composite layer to light in a predetermined pattern, the composite layer including the first photosensitive resin layer, the protective film, and the upper resin layer; a step of partly removing the exposed composite layer so as to form an opening exposing the substrate and form a groove along the main surface of the substrate on a side face of the opening by depressing the end portion of the upper resin layer on the substrate side, thereby forming a resist frame comprising the composite layer formed with the opening; a step of forming a vacuum coated layer having a material pattern part formed on the substrate in the opening and a part to lift off formed on the resist frame; and a step of removing the part to lift off in the vacuum coated layer together with the resist frame, so as to yield a patterned material layer.

In the above formation method, a resist frame having a groove formed on the side face of the opening, is formed by forming a composite layer including a first and second photosensitive resin layer. By employing a such resist frame it is possible to selectively remove (lift off) a portion formed on the resist frame (part to lift off) and the resist frame from the vacuum coated layer formed by vacuum coating. Furthermore, a protective film is provided between the first photosensitive resin layer and the upper resin layer, thus damage to the first photosensitive resin layer is prevented when forming the upper resin layer, and it is possible to form the resist frame structured by the composite layer with a high degree of precision on the basis of photolithography technology. By this method the material layer formed by vacuum coating can be directly patterned with the same high degree of precision as in the case of using frame plating. The patterned material layer has a shape that reflects the shape of the side surfaces of the first photosensitive resin layer structuring the resist frame. Accordingly, by controlling the shape of the side surfaces of the first photosensitive resin layer, it is easy to control the angle between the side surfaces of the patterned material layer and the substrate so that they are perpendicular.

The upper resin layer may further comprise an intermediate resin layer formed on the substrate side of the second photosensitive resin layer. In this case, the groove is formed on the side face of the opening by partly removing the intermediate resin layer so that the portion of the intermediate resin layer is depressed. Alternatively, the groove may be formed on the side face of the opening by partly removing the second photosensitive resin layer so that the end portion of the second photosensitive resin layer on the substrate side is depressed.

In the above step of partly removing the exposed composite layer, it is preferable that the protective film is removed together with the first photosensitive resin layer and the upper resin layer by dissolving the protective film in a developing solution. In this manner it is possible to even more easily form a resist frame that has a high resolution.

The protective film is preferably an alumina film. An alumina film has a high resistance to the solvent used when forming the upper resin layer. Moreover, an alumina film is soluble in a developing solution such as an alkaline developing solution, thus it is possible to remove the alumina film together with the first photosensitive resin layer and the upper resin layer by dissolving the alumina film in a developing solution.

It is preferable to form the vacuum coated layer so that the gap is formed between the material pattern part and the part to lift off near the groove. In this manner, the part to lift off can be selectively removed more accurately.

The formation method according to the present invention may further comprise a step of forming a plating layer on the substrate in the opening. In this case, the material pattern part is formed on the plating layer instead of being directly formed on the substrate. With this method a material layer having a plating layer and a vacuum coated layer is formed. With a plating method it is possible to form a material layer having a great thickness more efficiently than with vacuum coating.

The above vacuum coating is preferably sputtering or vacuum evaporation since it is particularly easy to form a film that allows the part to lift off to be selectively removed.

The manufacturing method for a microdevice according to the present invention comprises a step of forming a patterned material layer on a substrate by the above material pattern formation method of the present invention. Moreover, the microdevice of the present invention is obtainable by this manufacturing method for a microdevice of the present invention.

### BRIEF DESCRIPTION OF THE DRAWINGS

FIG. 1 is an end view showing a first embodiment of a formation method of a patterned material layer;

FIG. 2 is an end view showing the first embodiment of the formation method of the patterned material layer;

FIG. 3 is an end view showing the first embodiment of the formation method of the patterned material layer;

FIG. 4 is an end view showing the first embodiment of the formation method of the patterned material layer;

FIG. 5 is an end view showing the first embodiment of the formation method of the patterned material layer;

FIG. 6 is an end view showing the first embodiment of the formation method of the patterned material layer;

FIG. 7 is an end view showing the first embodiment of the formation method of the patterned material layer;

FIG. 8 is an end view showing the first embodiment of the formation method of the patterned material layer;

FIG. 9 is an end view showing the first embodiment of the formation method of the patterned material layer;

FIG. 10 is an end view showing the first embodiment of the formation method of the patterned material layer;

FIG. 11 is an end view showing a second embodiment of the formation method of the patterned material layer;

FIG. 12 is an end view showing the second embodiment of the formation method of the patterned material layer;

FIG. 13 is an end view showing the second embodiment of the formation method of the patterned material layer;

FIG. 14 is an end view showing the second embodiment of the formation method of the patterned material layer;

FIG. 15 is an end view showing a third embodiment of the formation method of the patterned material layer; and

FIG. 16 is a sectional view showing a magnetic head for perpendicular magnetic recording as a first embodiment of a microdevice.

### DESCRIPTION OF THE PREFERRED EMBODIMENTS

In the following, preferred embodiments of the present invention will be explained in detail with reference to the drawings. However, the present invention is not limited to the following embodiments. Parts identical or equivalent to each other will be referred to with numerals identical to each other without repeating their overlapping descriptions.

### First Embodiment

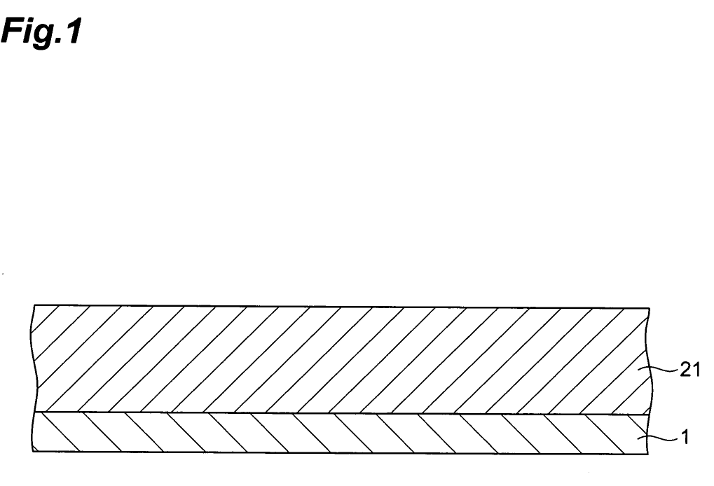

FIGS. 1 to 10 are end views showing a first embodiment of a formation method of a patterned material layer. The method according to the present invention comprises a step of forming a first photosensitive resin layer 21 on a substrate 1; a step of forming a protective film 28; a step of forming an upper resin layer 25 on the protective film 28; a step of exposing a composite layer 2 to light in a predetermined pattern, the composite layer 2 including the first photosensitive resin layer 21, the protective film 28, and the upper resin layer 25; a step of partly removing the exposed composite layer 2 to form a resist frame 2 comprising the composite layer formed with an opening 10; a step of forming a vacuum coated layer 3 by vacuum coating, the vacuum coated layer 3 having a material pattern part 31 formed on the substrate 1 in the opening 10 and a part to lift off 32 formed on the resist frame 2; and a step of removing the part to lift off 32 and the resist frame 2 of the vacuum coated layer 3 selectively so as to yield a patterned material layer 51 formed from the remaining material pattern part 31 on the substrate 1.

As shown in FIG. 1, in the first embodiment, the first photosensitive resin layer 21 is first formed on one surface of the substrate 1. The material for the substrate 1 is selected as appropriate in accordance with the application and the like of the formed material layer. More specifically, for example, a substrate is used that is formed from Si, ceramic (Al₂O₃, TiC or the like), or a polymer.

The photosensitive resin forming the first photosensitive resin layer 21 is a so-called positive type photosensitive resin in which the solubility thereof in a developing solution increases after exposure. As a photosensitive resin, a polyhydroxystyrene series, or the like, chemically amplified positive type photosensitive resin is preferred. It is preferable, as in the present embodiment, to use a positive type photosensitive resin to form the first photosensitive resin layer 21, however, a negative type of photosensitive resin can also be used. In such a case a negative type of photosensitive resin is also used to form the second photosensitive resin layer 22.

The first photosensitive resin layer 21 is formed, for example, by coating a photosensitive resin solution including a solvent on the substrate 1 by a spin coat method or the like, and then by drying the coated photosensitive resin solution. The dried first photosensitive resin layer 21 is prebaked as necessary. The thickness of the dried first photosensitive resin layer 21 is preferably between 0.1 and 10 micrometers.

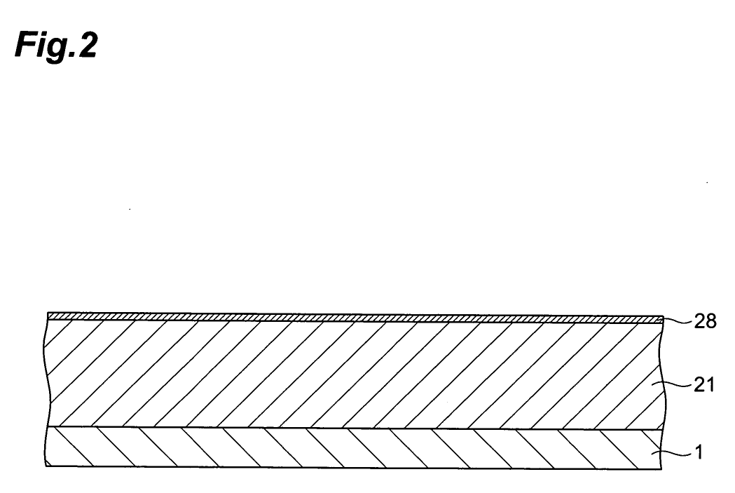

Then, the protective film 28 is formed on the side of the first photosensitive resin layer 21 opposite the substrate 1 (FIG. 2). The protective film 28 preferably covers the entire surface of the first photosensitive resin layer 21 on the side opposite the substrate 1, however, the protective film may be formed to cover only a portion of the first photosensitive resin layer 21. The protective film 28 is formed from a material that is soluble in a developing solution that is for developing the first photosensitive resin layer 21 and a second photosensitive resin layer 22 after they are exposed. Also, the protective film 28 is preferably transparent in order for the first photosensitive resin layer 21 and the second photosensitive resin layer 22 to be exposed simultaneously.

The protective film 28 is preferably one that is formed from an inorganic material, which is soluble in an alkaline developing solution, such as a metallic oxide or the like and an inorganic salt of sodium chloride or the like. More preferably, the protective film 28 is an alumina film consisting essentially of alumina. The method of forming the protective film 28 is not particularly restricted, however, for example in the case of an alumina film, the protective film 28 is preferably formed by vacuum coating such as a sputtering.

The thickness of the protective film 28 is preferably from 0.1 to 20 nanometers. If the thickness of the protective film 28 is less than 0.1 nanometers there is a tendency for difficulties to arise in sufficiently protecting the first photosensitive resin layer 21 when the upper resin layer 25 is formed. If the thickness of the protective film 28 exceeds 200 angstroms, the time needed to form the film lengthens and productivity is reduced.

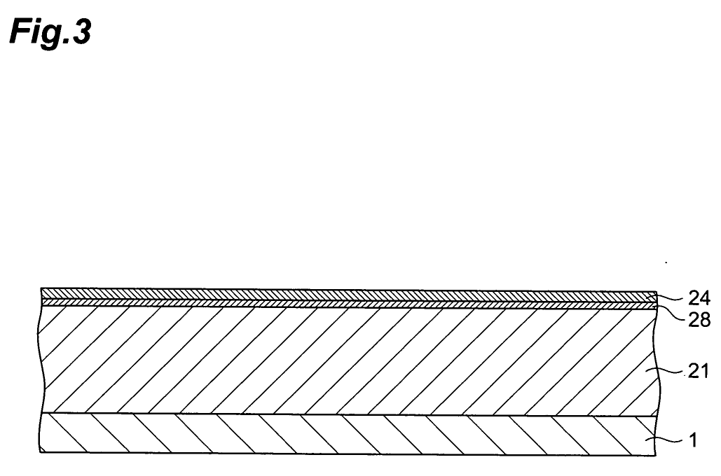

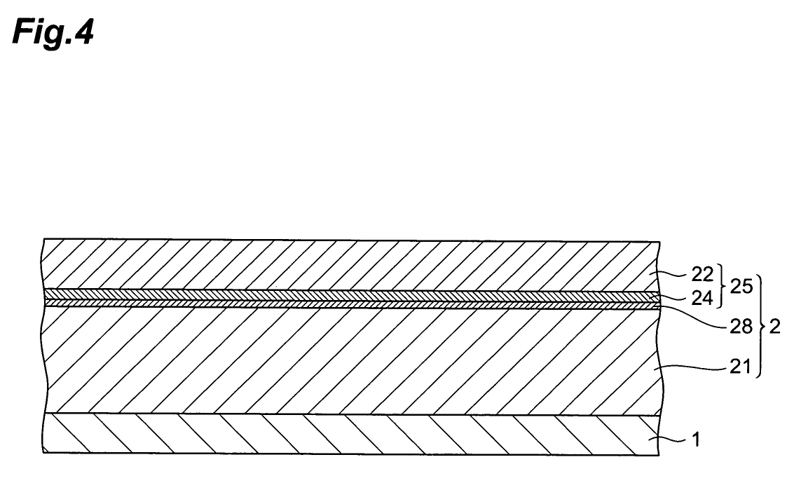

The step of forming the upper resin layer 25 on the protective film 28 includes a step of forming an intermediate resin layer 24 on the side of the protective film 28 opposite the substrate 1 (FIG. 3), and a step of forming the second photosensitive resin layer 22 on the intermediate resin layer 24 on the side opposite the protective film 28 (FIG. 4).

The solubility of the intermediate resin layer 24 to a developing solution is greater than the solubility, to the developing solution, of the unexposed portions of the first photosensitive resin layer 21 and the second photosensitive layer 22 after the layers are exposed. Due to the difference in the solubility to the developing solution, the intermediate resin layer 24 is removed until a depressed state is formed in the intermediate resin layer 24 on the side face of the opening 10 formed after developing.

More specifically, the intermediate resin layer 24 is formed from, for example, an alkali-soluble resin or a water-soluble resin. Alkali-soluble resins that can be used favorably as a resin forming the intermediate resin layer 24 include PMGI (polymethylglutarimide), polyvinyl alcohol, polyacrylic acid, polyvinyl acetal, polyvinyl pyrrolidone, polyethyleneimine, polyethylene oxide, styrene-maleic acid copolymer, polyvinylamine resin, polyallylamine, water-soluble resin containing an oxazoline group, water-soluble melamine resin, water-soluble urea resin, alkyd resin, and sulfonamide resin.

The intermediate resin layer 24 is formed, for example, by coating a resin solution including an alkali-soluble resin and a solvent on the protective film 28 by a spin coat method or the like, and then by drying the coated resin solution. The intermediate resin layer 24 is prebaked as necessary. Cyclopentanone, for example, is used as the solvent for the resin solution. In the case of the present embodiment, the protective film 28 prevents the first photosensitive resin layer 21 from being dissolved by the solvent for the resin solution.

The thickness of the intermediate resin layer 24 is preferably less than the thickness of the first photosensitive resin layer 21 and the second photosensitive resin layer 22. More specifically, the thickness of the intermediate resin layer 24 is in the range of 0.001 to 10 micrometers. If the thickness of the intermediate resin layer 24 is less than 0.001 micrometers, then a groove 23 formed through developing becomes narrow, and thus forming a gap between the material pattern part 31 and the part to lift off 32 tends to become difficult. If the thickness of the intermediate resin layer 24 exceeds 10 micrometers, then the groove 23 formed through developing becomes wide, the vacuum coated layer 3 is also formed in the groove 23, and thus forming a gap between the material pattern part 31 and the part to lift off 32 tends to become difficult. By forming a gap between the material pattern part 31 and the part to lift off 32, it is easy to selectively remove only the part to lift off 32 together with the resist frame 2, with the material pattern part 31 remaining.

The second photosensitive resin layer 22 is formed on the intermediate resin layer 24 and formed with the same photosensitive resin as the first photosensitive resin layer 21. The thickness of the second photosensitive resin layer 22 is preferably from 0.1 to 10 micrometers.

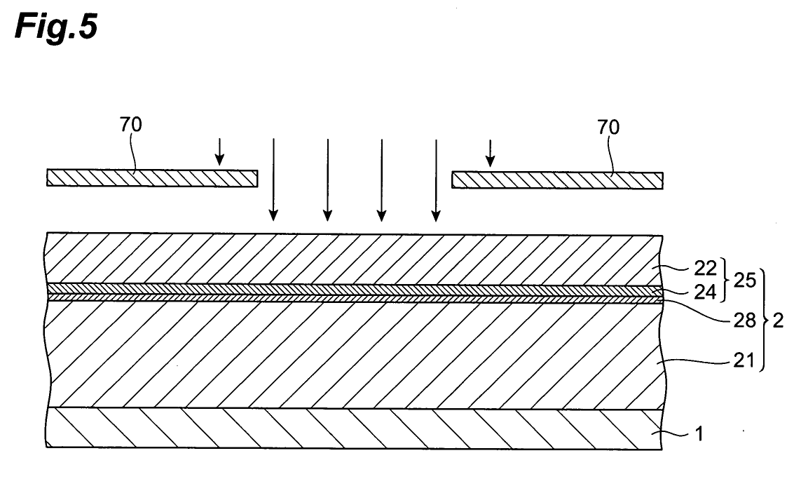

FIG. 5 is an end view showing the step of exposing a composite layer 2 to a light in a predetermined pattern, the composite layer 2 including the first photosensitive resin layer 21, the protective film 28 and the upper resin layer 25. The composite layer 2 is exposed to the prescribed pattern by illuminating an active light beam onto the composite layer 2 via a mask 70 having an opening. As the active light beam, for example, an I-line having a wavelength of 365 nm, light having a wavelength of 248 nm (KrF excimer laser), or light having a wavelength of 192 nm (ArF excimer laser) is used. The active light beam is illuminated by a stepper, scanner or the like.

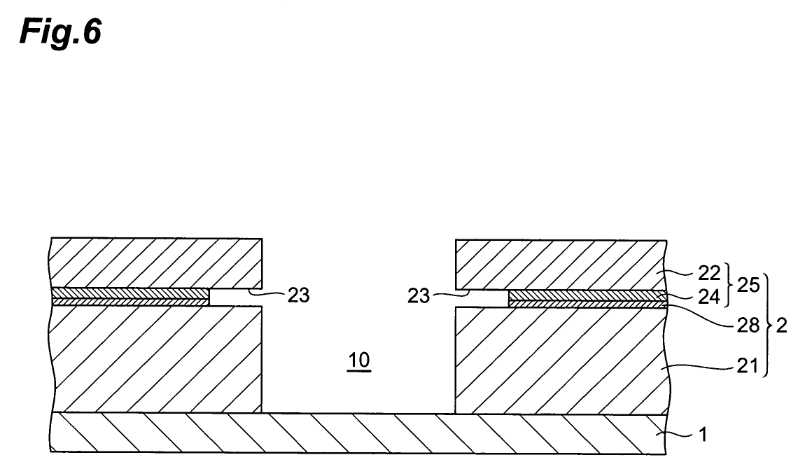

After exposure, as shown in FIG. 6, the opening 10 which exposes the substrate 1 is formed through development using a developing solution. When development takes place, the portions of the first photosensitive resin layer 21, the protective film 28 and the upper resin layer 25 that are illuminated by the active light beam (exposed portion) are removed by being dissolved in a developing solution. Furthermore, the developing solution penetrates into the unexposed regions of the intermediate resin layer 24 and the protective film 28, and the unexposed regions of the intermediate resin layer 24 and the protective film 28 are partially removed. As a result, on the side face of the opening 10, the portion of the intermediate resin layer 24 and the protective film 28 forms a depression. More specifically, the groove 23 is formed, along the main surface of the substrate 1, on the side face of the opening 10. After exposure, the composite layer 2 remaining on the substrate 1 is used as the resist frame. The depth of the groove 23 is preferably from 0.01 to 10 micrometers.

As the developing solution, a developing solution which can dissolve the protective film 28 and the intermediate resin layer 24 as well as the exposed part of the first photosensitive resin layer 21 and the second photosensitive resin layer 22 is available. Particularly, in the case of the present embodiment, in order to form the groove 23, the solubility of the protective film 28 and the intermediate resin layer 24 is higher than the solubility of the unexposed portion of the first photosensitive resin layer 21 and the second photosensitive resin layer 22.

Alkaline developing solutions such as aqueous solutions of tetramethylammonium hydroxide are specific examples of favorable developing solutions. The other developing conditions are the same as those in typical photolithography.

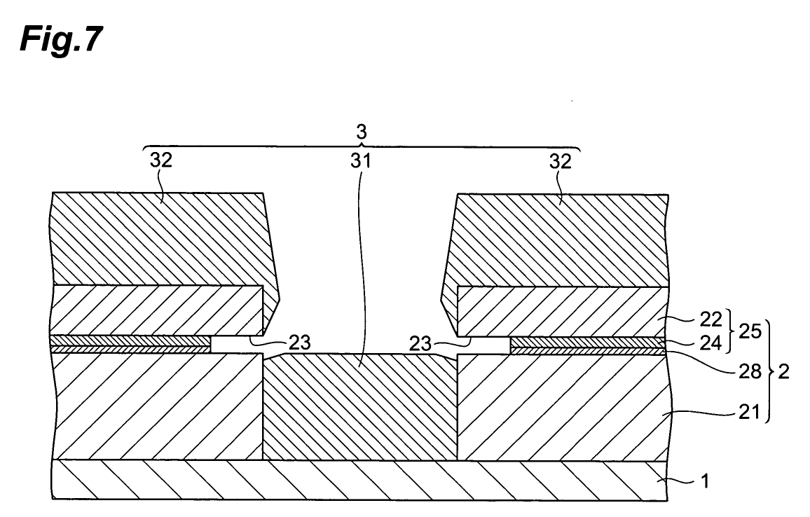

After forming the resist frame 2, as shown in FIG. 7, the vacuum coated layer 3 is formed by a vacuum coating. The vacuum coated layer 3 has the material pattern part 31 formed on the exposed substrate 1 of the base portion of the opening 10, and has the part to lift off 32 formed on the resist frame 2.

The groove 23 is formed on the side face of the opening of the resist frame 2, thus a gap is formed near the groove 23 between the material pattern part 31 and the part to lift off 32. In other words, the material pattern part 31 and the part to lift off 32 are separated from each other. To more effectively form this gap the thickness of the vacuum coated layer 3 (particularly, the thickness thereof in the opening 10) is preferably less than or equal to the thickness of the first photosensitive resin layer 21.

The vacuum coating is preferably sputtering or vacuum evaporation, sputtering in particular. The sputtering angle (the angle in relation to the main surface of the substrate 1) is preferably in the range of 70 to 90 degrees so that the gap is effectively formed near the groove 23.

The material for forming the vacuum coated layer is selected as appropriate in accordance with the application and the like of the patterned material layer. For example, NiFe (permalloy), CoNiFE and Cu can be selected. Particularly, when using the patterned material layer as a lead shield layer on a reproducing head of a thin film magnetic head, materials such as NiFe (permalloy), CoZrTa and sendust can be favorably used.

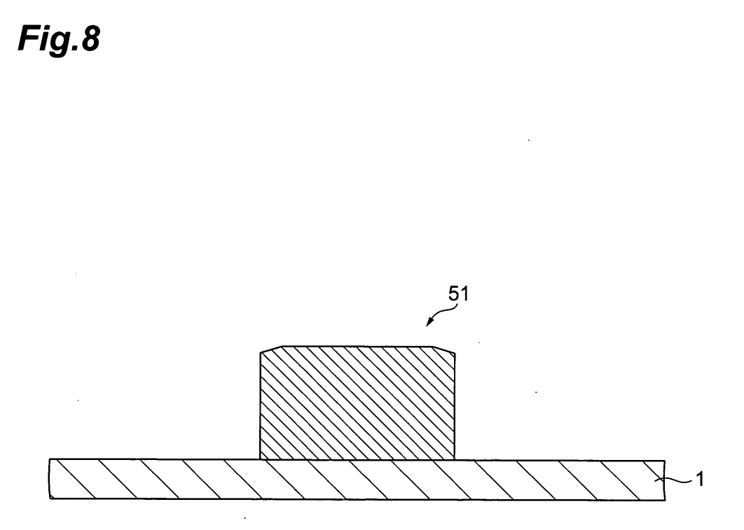

Next, by removing the part to lift off 32 from the vacuum coated layer 3 together with the resist frame 2, the material pattern part 31 remains on the substrate 1 as the patterned material layer 51 (FIG. 8). Removal of the resist frame 2 and the part to lift off 32 is performed using a solvent such as NMP or acetone, and is performed in the same manner as in typical photolithography.

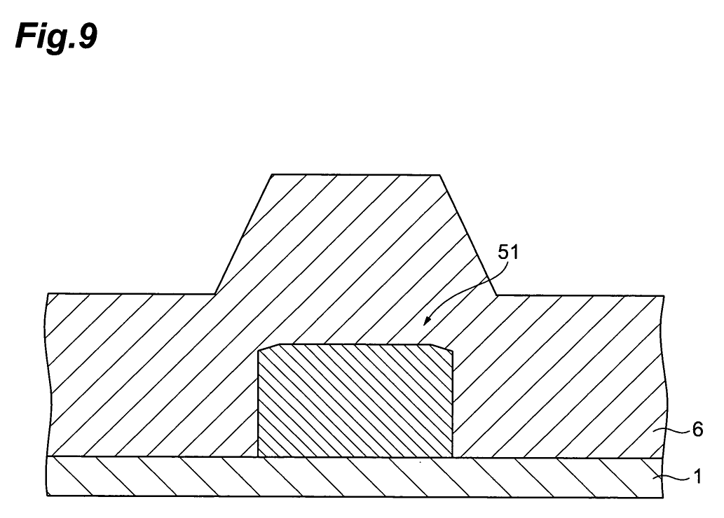

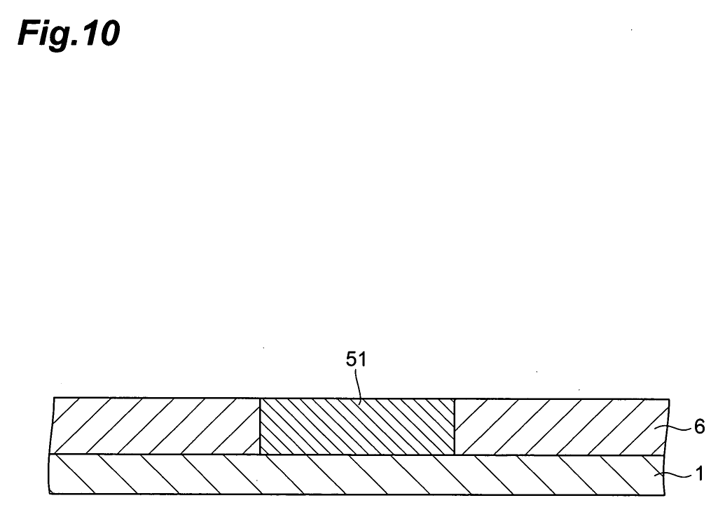

The present embodiment further comprises a step in which an auxiliary layer 6 is formed for covering the substrate 1 and the patterned material layer 51 (FIG. 9) and a step in which the material layer 51 and the auxiliary layer 6 are polished and the surface of the side opposite the substrate 1 is planarized (FIG. 10). Polishing can be performed by a well-known method such as a CMP method. For example, when the material layer 51 is used as a lead shield layer for a thin film, magnetic head, the auxiliary layer 6 is preferably formed from a non-magnetic insulating material such as alumina.

### Second Embodiment

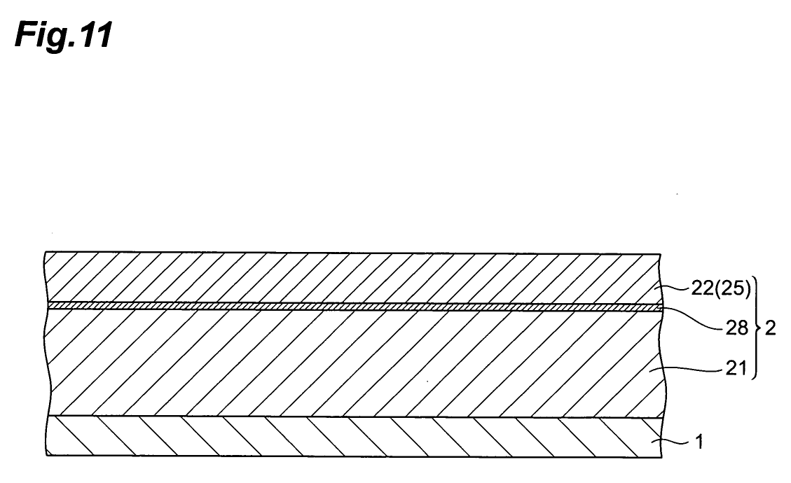

FIGS. 11 to 14 are end views showing a second embodiment of the formation method of the patterned material layer.

In the second embodiment, in the same manner as in the first embodiment, a first photosensitive resin layer 21 and the protective film 28 are formed on the substrate 1. Then, as shown in FIG. 11, the second photosensitive resin layer 22 is formed directly on the protective film 28 without forming an intermediate resin layer 24. The upper resin layer 25 is structured by only the second photosensitive resin layer 22. In the case of the present embodiment, by providing the protective film 28, damage to the first photosensitive resin layer 21, due to dissolving and the like from a solvent, is prevented when the second photosensitive resin layer 22 is formed.

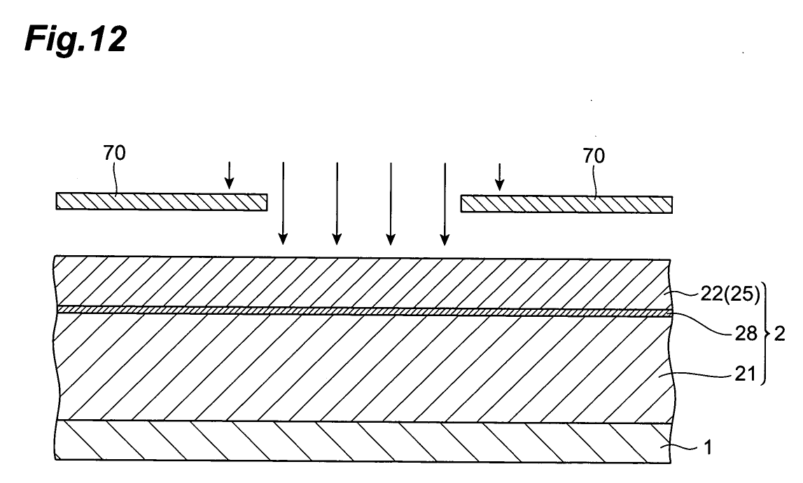

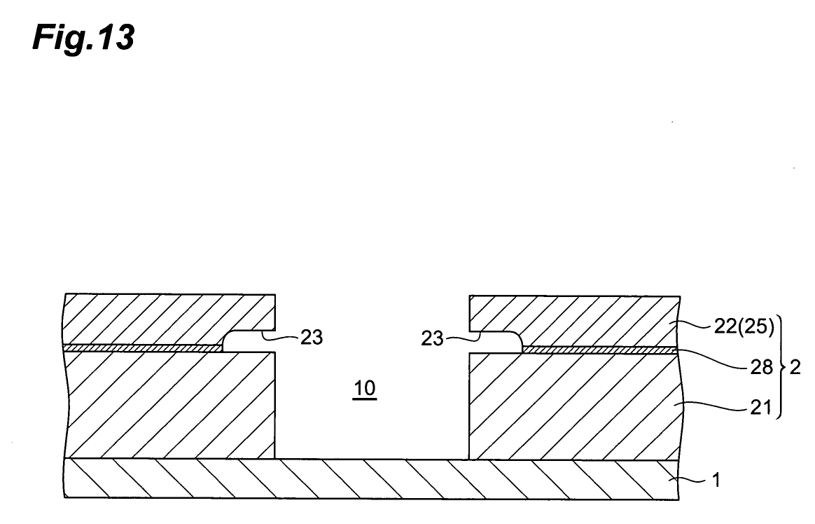

As shown in FIG. 12, in the same manner as in the first embodiment, the composite layer 2 is exposed to light in a predetermined pattern. After exposure the composite layer 2 is developed and the opening 10 for developing the substrate 1 is formed (FIG. 13). As a result of the developing, the second photosensitive resin layer 22 has a shape in which the end portions thereof on the side of the substrate 1 are depressed on the side faces of the opening 10. In this manner the groove 23 is formed along the main surface of the substrate 1. In the case of the present embodiment, the second photosensitive resin layer 22 is formed using a photosensitive resin in which the solubility to the developing solution after exposure to light is higher on the side opposite the side in which the active light beam falls on the second photosensitive resin layer 22. As an example of this type of photosensitive resin, the item disclosed in for example Japanese Unexamined Patent Application No. 10-97066 is known.

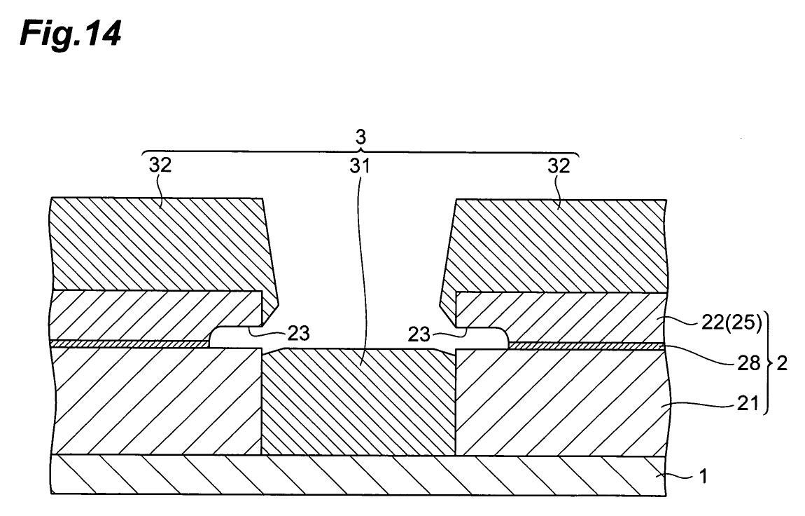

After development, as is shown in FIG. 14, the vacuum coated layer 3 is formed in the same manner as in the first embodiment. The part to lift off 32 formed on the resist frame 2 is selectively removed from the vacuum coated layer 3, together with the resist frame 2. The remaining steps are the same as those of the first embodiment.

### Third Embodiment

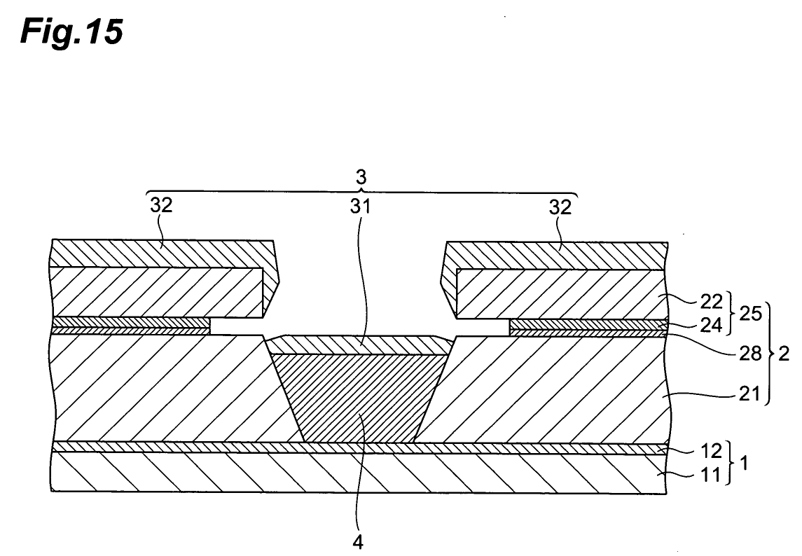

FIG. 15 is an end view showing a third embodiment of the formation method of the patterned material layer. In the case of the third embodiment, the material pattern part 31 is formed on a plating layer 4 after the step of forming the plating layer 4 on the substrate 1 in the opening 10.

The substrate 1 has a base 11 and an electrode film 12 for plating that is formed on the base 11. The base 11 is identical to the substrate 1 in the first embodiment, and the electrode film 12 for plating is formed by a sputtering method, a CVD method, a deposition method, an electroless plating method or the like from material (preferably the same material as the plating layer 4) that can be used as an electrode for plating such as a conductive metal, ceramic, or organic material.

In the present embodiment the wall surfaces of the first photosensitive resin layer 21 that structures the resist frame 2 is sloped relative to the main surface of the substrate 1. In correspondence to this sloped state, the material layer formed from the plating layer 4 and the material pattern part 31 has a trapezoidal cross section whose width gradually widens from the substrate 1. The side surfaces of the first photosensitive resin layer 21 can for example be sloped by applying heat greater than or equal to the glass transition temperature to cause the first photosensitive resin layer 21 to flow, after developing. Alternatively, a method may also be employed in which a photosensitive resin, having a low degree of transparency relative to the active light beam illuminated during the exposure step, is used for the first photosensitive resin layer 21. In this manner, according to the present invention, the angle formed by the side surfaces of the material layer formed in the substrate, relative to the main surface of the substrate, can be controlled easily to form a desired angle.

An explanation was given above of favorable embodiments of a formation method for a patterned material layer according to the present invention, with the first, second, and third embodiments serving as representative examples, however, the present invention is not limited to these embodiments, and appropriate modifications are possible to the extent that they do not deviate from the intent of the present inventions. For example, if the protective film 28 is insoluble, or has a low solubility, to the developing solution, in place of removing the protective film 28 by dissolving the protective film 28, together with the first photosensitive resin layer 21 and the upper resin layer 25, in the developing solution, the composite layer 2 may instead be developed via a step of removing the upper resin layer 25, a step of removing the protective film 28 by a milling method or the like, and a step of removing the first photosensitive resin layer 21.

The formed material layer, can be used as a layer structuring a microdevice such as, for example, a thin film magnetic head, a thin film inductor, a semiconductor device, a thin film sensor or a thin film actuator. More specifically, the patterned material layer according to the present invention, can be favorably used, for example, as a lead shield layer provided in a flux emission portion for recording or a reproducing head portion found in a thin film magnetic head such as magnetic heads for perpendicular magnetic recording.

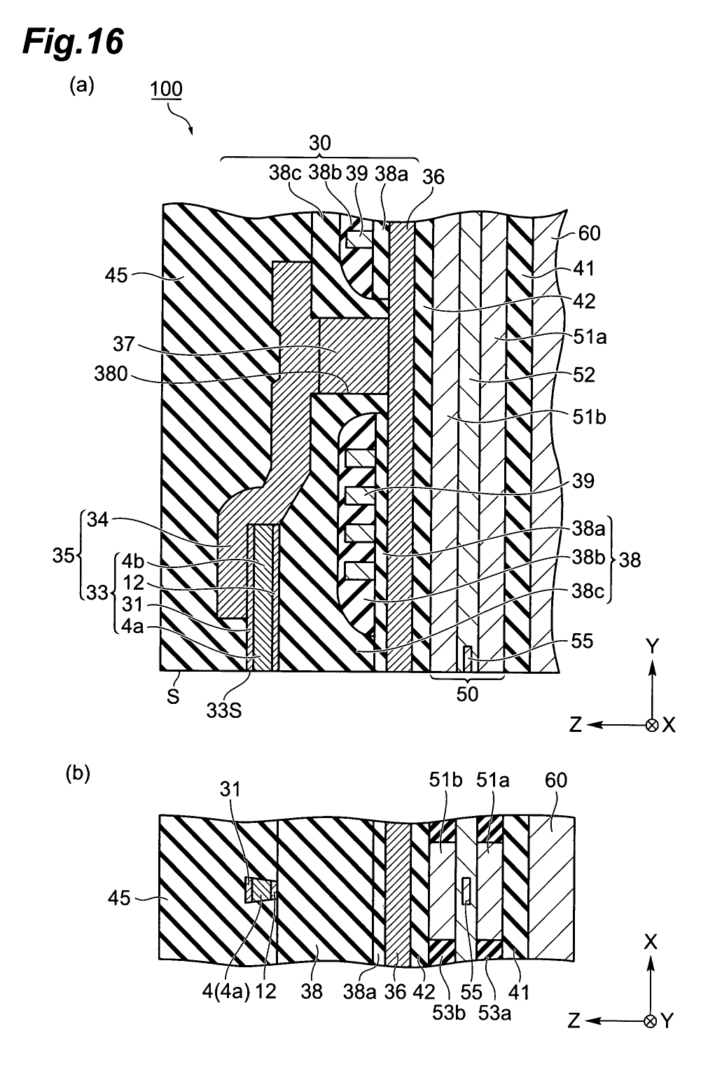

FIG. 16 is an end view showing a schematic of an embodiment of a microdevice. A microdevice 100 shown in FIG. 16 is a magnetic head for perpendicular magnetic recording. The magnetic head for perpendicular magnetic recording 100 performs an operation of recording magnetic information at a position in which a medium-opposing surface S, of the magnetic head for perpendicular magnetic recording 100, is disposed opposite a recording surface of a recording medium. (a) of FIG. 16 is a cross section from a view perpendicular to the side of the medium-opposing surface S, and (b) of FIG. 16 is an end view of the magnetic head for perpendicular magnetic recording 100 as seen from the medium-opposing surface S.

The magnetic head for perpendicular magnetic recording 100 is structured by laminating in sequence, on a substrate 60 formed from a ceramic material such as Al₂O₃ or TiC, an insulating layer 41 formed from a nonmagnetic insulating material, a reproducing head portion 50 which uses a magnetic resistance effect and which performs reading of magnetic information, a separating layer 42 formed from a nonmagnetic insulating material, a recording head portion 30 for executing magnetic recording processing, and an overcoat layer 45 formed from a nonmagnetic insulating material.

The reproducing head portion 50 is structured by laminating in sequence, a lower lead shield layer 51a adjacent to the insulating layer 41, a shield gap film 52, and an upper lead shield layer 51b. A magnetic resistance effect element 55 is embedded in the shield gap film 52 as a reproducing element, and one end surface of the magnetic resistance effect element 55 is exposed to the medium-opposing surface S. The magnetic resistance effect element 55 functions as a reproducing element by using for example a giant magneto-resistive effect (GMR) or a tunneling magneto-resistive effect (TMR) and by detecting magnetic information from the recording medium.

The lower lead shield layer 51a and the upper lead shield layer 51b are patterned so that they extend at a prescribed width in the direction along the medium-opposing surface S. An auxiliary layer 53a formed from a non-magnetic insulating material is provided on the sides of the lower lead shield layer 51a. In the same manner, an auxiliary layer 53b formed from a non-magnetic insulating material is provided on the sides of the upper lead shield layer 51b.

The side surfaces of the lower lead shield layer 51a and the upper lead shield layer 51b form angles relative to the main surface of the substrate 60 that are in actuality perpendicular. With the patterning performed by the method of the present invention, each lead shield layer is formed by a vacuum coating, and it is possible to maintain the side surfaces of the lead shield layers perpendicular relative to the main surface of the substrate 60. On the other hand, in the case in which a conventional method of performing patterning by milling the vacuum coated layer is used, gentle sloping of the side surfaces of the formed material layer, and the cross sectional shape of the material layer having acute angles to the substrate sides could not have been avoided. Generally, when the end surface shapes of layers formed from magnetic material have acute angles, the flux tends to concentrate in the portion of the acute angles. When flux concentrates in the end portions of the lead shield layers, unnecessary writing to the recording medium occurs, and a problem develops in which recorded information is erased. In response to this problem, in the case of the present embodiment, the cross section shapes of the lead shield layers do not have acute angles, thus the occurrence of this type of problem is prevented.

Moreover, each lead shield layer is formed by a vacuum coating, thus the lead shield layers have a high saturated magnetic flux density in comparison with the case in which the lead shield layers are formed with a plating method. Accordingly, the reproducing head 50 exhibits very superior performance with low noise, resolution power for reading, tolerance to outside magnetic fields, and the like. The vacuum coating has an advantage in that lead shield layers are easily formed with thin films. By forming the lead shield layers as thin films, developing in which elements partially bulge due to rises in temperatures is not likely to occur.

The recording head portion 30 is provided above the reproducing head portion 50, with the recording head portion 30 and the reproducing head portion 50 sandwiched around the separating layer 42. The recording head portion 30 has a structure formed by laminating in sequence an auxiliary magnetic pole 36 adjacent to the separating layer 42, a gap layer 38 embedded with a thin film coil 39, and a magnetic pole 35. The magnetic pole 35 and the auxiliary magnetic pole 36 are filled through an opening 380 of the gap layer 38 and are magnetically connected via a linking portion 37 formed from a magnetic material. The magnetic pole 35 is provided adjacent to the gap layer 38. More specifically, the magnetic pole 35 is provided on one surface of the main surface of a base, in which the base is the entire laminate formed from the gap layer 38 and the linking portion 37, under which the substrate 60, the reproducing head 50, the separating layer 42, the auxiliary magnetic pole 36, and the thin film coil 39 are embedded.

The magnetic pole 35 is structured to include a flux emission portion 33 having an exposed surface 33S that is exposed on the medium-opposing surface S side, and to include a yoke portion 34 formed as to cover the portion of the flux emission portion 33 that is on the side opposite the medium-opposing surface S and formed to connect magnetically to the linking portion 37.

The magnetic emission portion 33 has a structure formed by laminating a plating electrode film 12, plating layers 4a and 4b, and a material pattern part 31. The magnetic emission portion 33 is divided into a rod-shaped pole portion having the exposed surface 33S that is exposed on the medium-opposing surface S side, and a supporting portion that is provided on the side opposite the exposed surface 33S of the pole portion. The pole portion extends from the supporting portion with a rod-like shape. FIG. 16 shows the plating layer in the pole portion as 4a and the plating layer in the supporting portion as 4b.

In the case of magnetic heads for perpendicular magnetic recording, it is generally thought that a signal magnetic field is recorded on a recording medium with a perpendicular magnetic field on the basis of flux concentrated in the vicinity of the trailing edge, however, the side of the material pattern part 31 in the flux emission portion 33 becomes the trailing edge side when perpendicular magnetic recording is performed. If the material pattern part 31 is formed by the vacuum coating employed as the formation method according to the present invention, then the material pattern part 31 will have a high saturated magnetic flux density in comparison with the case in which the material pattern part 31 is formed with a plating method. Accordingly, the magnetic head for perpendicular magnetic recording 100, having a flux emission portion 33, demonstrates very superior recording properties.

Furthermore, due to the exposed surface 33S of the flux emission portion 33 having a trapezoidal shape, occurrence of so-called side erasing is suppressed, side erasing being caused by skewing of the magnetic head relative to the length direction of the track which is the object of recording. Performing patterning while controlling precision well enough so that the base angle of a material layer having a trapezoidal shaped cross section is a desired angle has previously been very difficult in the case of vacuum coatings such as a sputtering, however, by employing the method according to the present invention and patterning the flux emission portion 33, the base angle of the exposed surface 33S can be easily controlled.

The gap layer 38 is structured by three gap layer portions 38a, 38b and 38c. The gap layer portion 38a is provided adjacent to the auxiliary magnetic pole 36, and the thin film coil 39 is provided on the gap layer portion 38a, the thin film coil 39 forming a winding that has a spiral shape centered on the opening 380. The gap layer portion 38b is provided so as to cover each space between the windings of the thin film coil 39 and the region in the vicinity thereof. Furthermore, the gap layer portion 38c covers the gap layer portion 38b and forms the opening 380.

Among the portions of the magnetic head for perpendicular magnetic recording 100, those portions excepting the lower lead shield layer 51a, the upper lead shield layer 51b, and the flux emission portion 33 may be formed by employing appropriate materials and formation methods as normally used to manufacture thin film magnetic heads.

The thin film magnetic head according to the present invention is not limited to the magnetic head for perpendicular magnetic recording according to the above embodiment, and it goes without saying that appropriate modifications are possible to the extent that they do not deviate from the intent of the present invention.

What is claimed is:

1. A formation method for a patterned material layer, comprising the steps of:
forming a first photosensitive resin layer on a substrate;
forming a protective film covering the surface of the first photosensitive resin layer on the side opposite the substrate;
forming an upper resin layer on the protective film, the upper resin layer having a second photosensitive resin layer;
exposing a composite layer to light in a predetermined pattern, the composite layer including the first photosensitive resin layer, the protective film, and the upper resin layer;
partly removing the exposed composite layer so as to form an opening exposing the substrate and form a groove along the main surface of the substrate on a side face of the opening by depressing the end portion of the upper resin layer on the substrate side, thereby forming a resist frame comprising the composite layer formed with the opening;
forming a vacuum coated layer having a material pattern part formed on the substrate in the opening and a part to lift off formed on the resist frame, by vacuum coating process; and
removing the part to lift off in the vacuum coated layer together with the resist frame, so as to yield a patterned material layer.

2. The formation method according to claim 1,
wherein the upper resin layer further comprises an intermediate resin layer provided on the substrate side of the second photosensitive resin layer, and
the groove is formed on the side face of the opening by partly removing the intermediate resin layer so that the portion of the intermediate resin layer is depressed.

3. The formation method according to claim 1,
wherein the groove is formed on the side face of the opening by partly removing the second photosensitive resin layer so that the end portion of the second photosensitive resin layer on the substrate side is depressed.

4. The formation method according to claim 1,
wherein in the step of partly removing the exposed composite layer, the protective film is removed together with the first photosensitive resin layer and the upper resin layer by dissolving the protective film in a developing solution.

5. The formation method according to claim 1,
wherein the protective film is an alumina film.

6. The formation method according to claim 1,
wherein the vacuum coated layer is formed so as to yield a gap between the material pattern part and the part to lift off near the groove.

7. The formation method according to claim 1, further comprising a step of forming a plating layer on the substrate in the opening, wherein the material pattern part is formed on the plating layer.

8. The formation method according to claim 1,
wherein the vacuum coating is a sputtering or a vacuum evaporation.

9. A patterned material layer obtainable by the formation method according to claim 1.

10. A manufacturing method for a microdevice, including the step of forming a patterned material layer on a substrate by the formation method according to claim 1.

11. A microdevice obtainable by the manufacturing method for a microdevice according to claim 10.
